(19) United States
(12) Patent Application Publication
(10) Pub. No.: US 2012/0015088 A1
(43) Pub. Date: Jan. 19, 2012

(54) DEVICE AND METHOD FOR MIXING AND HEAT TREATING A LIQUID PRODUCT

(75) Inventors: Torsten RUNGE, Straubing (DE); Siegfried BOBON, Unna (DE)

(73) Assignee: KRONES AG, Neutraubling (DE)

(21) Appl. No.: 13/183,525

(22) Filed: Jul. 15, 2011

(30) Foreign Application Priority Data
Jul. 16, 2010 (DE) 102010031477.3

(51) Int. Cl. A23L 2/46

(52) U.S. Cl. 426/511; 99/323.1

(57) ABSTRACT

A device and a method for mixing and heat treating a liquid product, in particular a beverage, and having a first supply pipe for providing a product concentrate and a second supply pipe for providing an aqueous dilution liquid for diluting the product concentrate, as well as a first steam injector provided at the first supply pipe to introduce a first steam quantity flow into the product concentrate, and a second steam injector provided at the second supply pipe to introduce a second steam quantity flow into the dilution liquid. The product concentrate and the dilution liquid can be simultaneously heat treated and diluted, and the heat supply can be interrupted with an only slight delay in case of a production interruption to prevent overheating of the product.

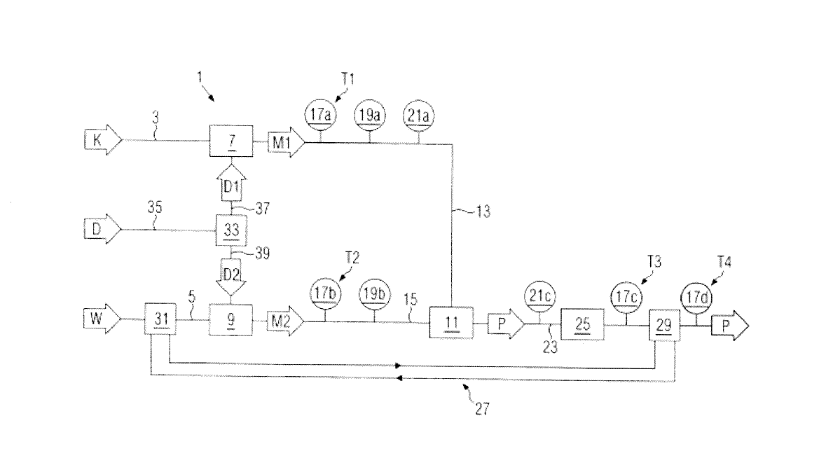

### CROSS-REFERENCE TO RELATED APPLICATION

The present application claims the benefit of priority of German Application No. 102010031477.3, filed Jul. 16, 2010. The entire text of the priority application is incorporated herein by reference in its entirety.

### FIELD OF THE DISCLOSURE

The disclosure relates to a device and a method for mixing and heat treating a liquid product, in particular a beverage.

### BACKGROUND

Finished beverages can be mixed by combining a product concentrate and a dilution liquid, such as water, in a predetermined mixing ratio both in a batch operation and as continuous partial product flows. In most cases, the product is thermally treated to ensure a certain shelf life or product quality after the product has been mixed.

With this procedure, however, it is neither possible to quickly start nor shut down the system in case of a standstill of a filling unit that follows in the product flow. This requires a considerable amount of equipment for intermediate product storage and/or causes product losses.

As an alternative, WO 02/094040 A1 suggests to heat a dilution liquid in a first heat exchanger, to mix a first proportion of the heated dilution liquid with a product concentrate, and to heat this mixture in a second heat exchanger. The heat-treated mixture is then combined with a second proportion of the previously heated dilution liquid to finally mix the product.

This, however, also requires a great amount of equipment and cannot satisfactorily solve the above mentioned problems in case of a production interruption.

Therefore, there is a demand for a method improved in this respect and a device simplified compared to that of prior art.

### SUMMARY OF THE DISCLOSURE

The present disclosure includes a first supply pipe for supplying a product concentrate; a second supply pipe for supplying an aqueous dilution liquid for diluting the product concentrate; a first steam injector provided at the first supply pipe to introduce a first steam quantity flow into the product concentrate; and a second steam injector provided at the second supply pipe to introduce a second steam quantity flow into the dilution liquid. Thereby, the product concentrate and the dilution liquid can be simultaneously heat treated and diluted. In particular the product concentrate can be diluted in the process to a concentration particularly suited for final mixing. Steam injection can be easily dosed and quickly interrupted in case of a production standstill, so that undesired long dwell times of the product concentrate at high temperatures can be avoided. Steam injection permits a stop-and-go operation, if required, whereby product buffers become dispensable or at least are required to a lesser extent. Furthermore, product losses as a consequence of product overheating can be avoided. The steam injectors can be connected to a common steam supply system which can further reduce the amount of required equipment. In particular, an additional heat exchanger for the dilution liquid is dispensable.

An advantageous embodiment of the device according to the disclosure furthermore comprises a mixing means for mixing the product concentrate to which steam was admitted by means of the first steam injector, and the dilution liquid to which steam was admitted by means of the second steam injector. Thereby, the partial product flows heat treated and diluted in this manner can be mixed at a predetermined mixing ratio when they are brought together. Therefore, a separate mixing system is dispensable. Thus, investment costs, maintenance costs and space requirements can be reduced.

In a particularly advantageous embodiment of the device according to the disclosure, between the first steam injector and the mixing means, a measuring device for determining the concentration of an ingredient characteristic of the quality of the product is provided in the product concentrate to which steam is admitted, in particular for determining the sugar content. By this, the concentration of the product concentrate diluted with the condensed first steam quantity flow can be measured and a range of values favorable for subsequent mixing can be observed. To this end, for example the first steam quantity flow can be adjusted depending on the concentration measured with the concentration meter downstream of the first steam injector.

Between the first steam injector and the mixing means and between the second steam injector and the mixing means, a flow meter and a temperature measuring device for monitoring the concentrate to which the steam is admitted and the dilution liquid to which the steam is admitted are preferably provided each. Thereby, both the quality of the heat treatment and the mixing ratio in the mixed product can be monitored or adjusted.

An advantageous embodiment furthermore comprises an adjustor to adjust the first and the second steam quantity flows. Thereby, a minimum temperature for the heat treatment in the concentrate and in the dilution liquid can be observed and simultaneously, a dilution favorable for mixing can be in particular adjusted in the concentrate.

Preferably, a heat retention means connected downstream of the mixing means is furthermore provided. Thereby, heat treatment can be extended until a possibly required total treatment duration is reached. Thus, heat treatment can be adapted to a certain quality requirement, for example for pasteurization or sterilization, even with an unchanged first steam quantity flow.

The method comprises the following steps: a) providing a product concentrate; b) providing an aqueous dilution liquid for diluting the product concentrate; c) providing steam; c) introducing a first steam flow into the provided product concentrate to thermally treat and dilute the latter; and d) introducing a second steam flow into the provided dilution liquid to thermally treat and dilute the latter. Thus, two production processes, that is a thermal treatment and an adjustment of a dilution suited for mixing, can be combined in one process. Steam injection is moreover suited for a plurality of different products, for example also for fibrous products or products containing pieces of fruit.

Preferably, the product concentrate and the dilution liquid are provided as continuous flows and steam is admitted to them in parallel. Thus, both flows can be treated and diluted simultaneously or at least overlapping in time. The flows and the steam supply can be quickly interrupted if required, to avoid undesired heating of the concentrate.

In a particularly advantageous embodiment of the method, the concentration of an ingredient characteristic of the quality of the product in the product concentrate to which steam is admitted is measured upon condensation of the introduced steam, in particular to determine the sugar content. Thus, the introduced steam quantity flow can be easily taken into consideration when concentration is measured, and concentration can be measured with high precision. Preferably, a Brix value is measured here.

Preferably, a quantity flow of the product concentrate to which steam was admitted and a quantity flow of the dilution liquid to which steam was admitted are measured each upon condensation of the introduced steam. Thereby, the introduced steam quantity can be easily taken into consideration for a measurement of the total contents, together with the provided quantity flow of the product concentrate and the dilution liquid. However, it would also be possible to measure each the first and the second steam quantity flow separately, for example while they are introduced into the steam injectors, and also the quantity flows of the product concentrate and the dilution liquid before the steam is introduced.

Preferably, the ratio of the quantity flows is adjusted depending on the concentration of an ingredient characteristic of the quality of the product measured in the mixed product, in particular the sugar content. Thereby, the product quality can be continuously adapted to a target during the mixing process. For this, the Brix value is particularly suited as a control parameter.

Preferably, the concentrate and the dilution liquid to which steam was admitted are brought together in the form of first and second aqueous mixing phases in a predetermined mixing ratio, in particular as measured quantity flows, to finally mix the product. Thereby, a predetermined product quality can be easily adjusted.

In an advantageous embodiment, by the introduction of the steam into the product concentrate and the dilution liquid, a minimum temperature is achieved, in particular for pasteurization or sterilization of the product. Thereby, a separate heating of the mixed product becomes dispensable or is at least reduced. Consequently, product losses due to undesired overheating of the finally mixed product as a consequence of product standstills are reduced.

Preferably, the finally mixed product is kept warm by retaining a minimum temperature, in particular for pasteurization or sterilization of the product. Thereby, even products that require a comparably long treatment time can be heat treated, diluted and mixed with a high throughput. Thus, in these cases, too, a predetermined mixing ratio can be exactly kept.

In a particularly advantageous embodiment of the method, heat withdrawn from the mixed and heat treated product is returned for preheating the dilution liquid. Thereby, thermal energy can be efficiently recovered and supplied to the dilution liquid which is not critical with respect to potential overheating. The device can thus be operated inexpensively and without restrictions in product quality in case of a production standstill.

### BRIEF DESCRIPTION OF THE DRAWING

A preferred embodiment of the device according to the disclosure is represented in the drawing. The single FIGURE shows a diagram of the device.

### DETAILED DESCRIPTION

Accordingly, the device 1 according to the disclosure, which preferably permits continuous mixing, comprises a first supply pipe 3 for a product concentrate K and a second supply pipe 5 for a dilution liquid W, such as water. At the supply pipes 3, 5, one steam injector 7, 9 each is provided for introducing a first steam flow D1 into the product concentrate K, and a second steam flow D2 into the dilution liquid W. The steam flows D1, D2 can heat the product concentrate K and the dilution liquid W to target temperatures T1, T2. The latter are preferably identical, but can also vary depending on the product P. The steam flows D1, D2 condense and mix with the product concentrate K and the dilution liquid W to form aqueous mixing phases M1 and M2. In the process, the mass flows of the product concentrate K and the first steam flow D1 add to the mass flow of the first mixing phase M1, the mass flows of the dilution liquid W and the second mass flow D2 add to the mass flow of the second mixing phase M2.

The device 1 furthermore comprises a controllable mixing means 11 which can be, for example, a nozzle or an injector, to combine the mixing phases M1, M2 to a finally mixed product P in an adjustable ratio. The injectors 7, 9 are connected with the mixing means 11 by means of connection pipes 13, 15, a temperature measuring device 17a, 17b and a flow meter 19a, 19b being provided at each of them. It will be understood that the mixing means 11 can comprise sections of the connection pipes 13, 15 to adjust the mixing ratio of the mixing phases M1, M2 at them or in the region of the injectors 7, 9.

At the connection pipe 13 for the mixing phase M1, a concentration meter 21a is furthermore provided to measure the concentration of a characteristic ingredient of the product P, such as the sugar content, in particular the Brix value of the mixing phase M1. A corresponding concentration meter 21c is provided at a product pipe 23 leading away from the mixing means 11. The latter in turn leads to a heat retention means 25 whose functioning is well-known from prior art and is therefore not described more in detail. However, it is preferably designed such that a minimum temperature or a target temperature T3 for the heat treatment of the product P, as in the region of the steam injectors 7, 9, is not fallen below. Preferably, a further temperature measuring device 17c is provided in the outlet region of the heat retention device 25 for temperature control. If the temperatures T1 and T2 of the mixing phases M1 and M2 differ from each other, the temperature T3 of the finally mixed product P is preferably a mixed temperature between T1 and T2.

Optionally, the device 1 according to the disclosure can comprise a heat return means 27 with a heat exchanger 29 on the outlet side and a heat exchanger 31 on the inlet side, with respect to the product flow, to withdraw heat from the heat treated product P before filling and supply it to the dilution liquid W to preheat it before it is introduced into the second injector 9. Thus, heating energy can be recovered, where the preheating of the dilution liquid W is less critical with respect to the product quality in case of a production standstill than a preheating of the concentrate K which would in principle be possible in an analogous manner. Furthermore, a pertaining temperature measuring device 17d on the outlet side for determining a product temperature T4 on the outlet side downstream of the heat exchanger 29 on the outlet side is represented.

The steam quantity flows D1, D2, which are preferably defined as mass flows (mass per time unit), can be adjusted at the injectors 7, 9, or at a suited adjustor 33. In the example, the latter is supplied by a common steam pipe 35 and connected to the injectors 7, 9 via distributor pipes 37, 39. However, it will be understood that for each injector 7, 9, a separate steam supply would be possible. It is decisive that the steam quantity flows D1, D2 can be adjusted, and that the injectors 7, 9 can be supplied with steam D in a parallel operation, so that steam D can be admitted both to the product concentrate K and the dilution liquid W essentially simultaneously.

The steam quantity flows D1, D2 can be adjusted such that a minimum temperature T1, T2 predetermined for the heat treatment is reached in the product concentrate K and in the dilution liquid W and that the product concentrate K is diluted to a concentration suited for subsequent mixing. By dilution, a desired concentration of the mixed product P can be adjusted more precisely.

Not shown is a preferably provided control means which permits to adjust the steam quantity flows D1, D2, depending on the measuring results of the measuring devices 17a, 17b, 19a, 19b and 21a by means of the injectors 7, 9 and/or the adjustor 33. The concentration meter 21a may, however, only have a control function. Preferably, the concentration meter 21c on the outlet side for the mixed product P is included in the control in order to monitor and/or adjust not only the steam quantity flows D1, D2, but also the quantity flows of the mixing phases M1, M2 for mixing the product P in the mixing means 11.

One can work as follows with the device 1 according to the disclosure:

The product concentrate K could be continuously supplied to the first injector 7 for example with a Brix value of 40 to 60° Bx and at room temperature. Correspondingly, fresh water W could be continuously supplied to the second injector 9 as dilution liquid at a temperature of, for example, 10 to 20° C. Optionally, preheating in the heat exchanger 31 on the inlet side is conceivable. The quantity flow of the fresh water W could be, for example, three to four times higher than the quantity flow of the product concentrate K to adjust a Brix value of for example 10° Bx in the finally mixed product P.

Via the steam pipe 35, water vapor D is provided, for example at an overpressure of 2 bar and distributed to the first and the second steam quantity flows D1, D2, where the second steam quantity flow D2 could be, for example, four to six times greater than the first steam quantity flow D1.

The steam flows D1, D2 are continuously and simultaneously lead into the injectors 7, 9, and steam D is admitted to the product concentrate K and the fresh water W. By this, for example a treatment temperature T1, T2 of 80 to 140° C., preferably 90 to 100° C., can be reached in or downstream of the injectors 7, 9 and monitored with the temperature measuring devices 17a, 17b.

Upon condensation of the steam D in the injectors 7, 9 and/or the connection pipes 13, 15, the volume flow rate through the connection pipes 13, 15 can be measured. In combination with the concentration measurement in the mixing phase M1, in which for example a reduction of the Brix value by 10% compared to the original concentration of the product concentrate K could be determined by adjusting the quantity flows of the mixing phases M1, M2, the desired concentration value of the mixed product P can be adjusted. Here, the concentration meter 21c permits continuous monitoring of the mixed product P and an optionally required correction of the quantity flows D1, D2, M1 and/or M2. Of course, the quantity flows of the supplied concentrate K and the dilution liquid W can also be changed on this basis.

The mixed product P can be continuously supplied to a cooling unit, an optionally following buffer tank, and finally a filling machine.

In case of a production standstill, in particular in the filling unit, both the steam supply D and the supply of the product concentrate K and the dilution liquid W can be quickly interrupted, so that undesired heating of product concentrate K standing in the device 1 or a mixing phase, such as the mixing phase M1, or the mixed product P, can be prevented. In contrast to heat transfer in conventional heat exchangers, the device 1 according to the disclosure reacts nearly without any delay and makes an additional product return circle during a product standstill dispensable and/or prevents quality loss by excessive heating of product ingredients.

Both the device 1 and the method according to the disclosure are suited for a plurality of liquid products, in particular for standard beverages, such as fruit juices and the like.

1. A device (1) for mixing and heat treating a liquid product (P), in particular a beverage, comprising:
a first supply pipe for providing a product concentrate (K);
a second supply pipe for providing an aqueous dilution liquid (W) for diluting the product concentrate;
a first steam injector provided at the first supply pipe to introduce a first steam quantity flow (D1) into the product concentrate; and
a second steam injector provided at the second supply pipe to introduce a second steam quantity flow (D2) into the dilution liquid.

2. The device according to claim 1, and a mixing means for mixing the product concentrate (K) to which steam (D1) was admitted by means of the first steam injector, and the dilution liquid (W) to which steam (D2) was admitted by means of the second steam injector.

3. The device according to claim 2, and wherein between the first steam injector and the mixing means, a measuring device (21a) for determining the concentration of an ingredient characteristic of the quality of the product (P) in the product concentrate (M1) to which steam was admitted is provided.

4. The device according to claim 2, and wherein between the first steam injector and the mixing means, and between the second steam injector and the mixing means, one flow meter and one temperature measuring device each are provided to monitor the concentrate (M1) to which steam was admitted and the dilution liquid (M2) to which steam was admitted.

5. The device according to claim 1, and an adjustor to adjust the first and the second steam quantity flows (D1, D2).

6. The device according to claim 2, and wherein furthermore a heat retention means connected downstream of the mixing means.

7. The method for mixing and heat treating a liquid product (P), in particular a beverage, comprising the steps of:
a) providing a product concentrate (K);
b) providing an aqueous dilution liquid (W) for diluting the product concentrate;
c) providing steam (D);
d) introducing a first steam flow (D1) into the provided product concentrate to thermally treat and dilute the latter; and
e) introducing a second steam flow (D2) into the provided dilution liquid to thermally treat and dilute the latter.

8. The method according to claim 7, and providing the product concentrate (K) and the dilution liquid (W) as continuous flows to which steam is admitted (D) in parallel.

9. The method according to claim, and measuring the concentration of an ingredient characteristic of the quality of the product in the product concentrate (K) to which steam (D) was admitted upon condensation of the introduced steam (D).

10. The method according to claim 7, and measuring each of a first quantity flow of the product concentrate (M1) to which steam was admitted and a second quantity flow of the dilution liquid (M2) to which steam was admitted upon condensation of the introduced steam (D).

11. The method according to claim 10, and adjusting the ratio of the first to the second quantity flow depending on the concentration of an ingredient characteristic of the quality of the product measured in the mixed product (P).

12. The method according to claim 7, and bringing together the product concentrate (K) to which steam (D) was admitted, and the dilution liquid (W) to which steam (D) was admitted in the form of first and second aqueous mixing phases (M1, M2) in a predetermined mixing ratio.

13. The method according to claim 7, wherein by the introduction of the steam (D) into the product concentrate (K) and into the dilution liquid (W), a minimum temperature (T1, T2) is reached.

14. The method according to claim 7, wherein the mixed product (P) is kept warm retaining a minimum temperature (T3).

15. The method according to claim 7, and returning the heat withdrawn from the mixed and heat treated product (P) for heating the dilution liquid (W).

16. The device according to claim 3, wherein the determined concentration of an ingredient characteristic of quality is the sugar content.

17. The method according to claim 9, wherein measuring the concentration of an ingredient characteristic of quality is to determine the sugar content.

18. The method according to claim 11, wherein the ingredient characteristic of the quality is the sugar content.

19. The method according to claim 12, wherein the first and second aqueous mixing phases are quantity flows measured upon condensation of the steam (D) to mix the product (P).

20. The method according to claim 13, wherein the minimum temperature is reached for pasteurization or sterilization of the product.

21. The method according to claim 14, wherein the mixed product is kept warm for pasteurization or sterilization of the product.
